(19) United States
(12) Patent Application Publication
(10) Pub. No.: US 2021/0273484 A1
(43) Pub. Date: Sep. 2, 2021

(54) ENERGY HARVESTING DEVICE

(71) Applicant: Bryan Stringham, Provo, UT (US)

(72) Inventor: Bryan Stringham, Provo, UT (US)

(21) Appl. No.: 16/806,888

(22) Filed: Mar. 2, 2020

(51) Int. Cl. H02J 15/00; F03G 3/06

(52) U.S. Cl. CPC H02J 15/007; H02J 2300/20; F03G 3/06

(57) ABSTRACT

An energy harvesting device may include a hub structure configured to rotate about an axis. The energy harvesting device may further include a first arm. The first arm may include a hinge connecting a first proximal end of the first arm to the hub structure. The first arm may further include a first weight coupled to a first distal end of the first arm. The energy harvesting device may include a second arm. The second arm may include a second hinge connecting a second proximal end of the second arm to the hub structure. The energy harvesting device may further include a second weight coupled to a second distal end of the second arm.

### BACKGROUND

Mechanical systems, such as hand pumps, may be located in remote locations. Sensor data associated with a mechanical system may be used to determine whether the mechanical system is damaged, whether preventative maintenance is to be performed, how to improve the mechanical system, how to improve infrastructure of mechanical systems, how the mechanical system is being operated, and/or the like. To transmit sensor data, a mechanical system is to be coupled to an energy source. In one example, a mechanical system has a wired connection to an energy source (e.g., is hard-wired). In another example, a mechanical system has a replaceable energy source, such as one or more disposable batteries.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an energy harvesting device, according to certain embodiments.

FIG. 2 illustrates an energy harvesting device, according to certain embodiments.

FIG. 3A illustrates an energy harvesting device with bumpers attached to hub structure to convert rotational kinetic energy into electric energy, according to certain embodiments.

FIG. 3B illustrates an energy harvesting device with recesses in hub structure to convert rotational kinetic energy into electric energy, according to certain embodiments.

FIG. 4A illustrates an energy harvesting device formed from a single piece of material, according to certain embodiments.

FIG. 4B illustrates an energy harvesting device with hinges, according to certain embodiments.

FIG. 4C illustrates an energy harvesting device with hinges with protrusions, according to certain embodiments.

FIG. 5 illustrates an energy harvesting device with a ratcheting structure on a hub, according to certain embodiments.

FIG. 6 shows an energy harvesting device at various instances of rotation, according to certain embodiments.

FIG. 7 illustrates an energy harvesting system with an energy harvesting device, according to certain embodiments.

FIG. 8 illustrates an energy harvesting device coupled to an oscillation rotational structure, according to certain embodiments.

FIG. 9 is system including a hand pump with an energy harvesting device coupled to a pump handle of a hand pump, according to certain embodiments.

FIG. 10A is an energy harvesting system including a train with an energy harvesting device coupled to a strut of the train, according to certain embodiments.

FIG. 10B is an energy harvesting system including an oil rig with an energy harvesting device coupled to an arm of the oil rig, according to certain embodiments.

FIGS. 11A-11D are block diagrams illustrating various energy harvesting systems, according to certain embodiments.

FIG. 12 is a flow diagram of a method associated with an energy harvesting device, according to certain embodiments.

FIG. 13 is a diagrammatic representation of a machine in the example form of a computer system including a set of instructions executable by a computer system, according to any one or more of the methodologies discussed herein.

### DETAILED DESCRIPTION OF EMBODIMENTS

Embodiments described herein are related to an energy harvesting device. In some embodiments, the energy harvesting device is coupled to an oscillating rotational structure. In some embodiments, the energy harvesting device is designed such that various components of the device are elastic (e.g., uses compliant mechanisms, are flexible, etc.).

Hundreds of millions of people across the globe live without access to safe water. Women and children are disproportionately affected by the water crisis, as women and children are often responsible for collecting water, which takes time away from work, school, play, and caring for family. In 2017, an estimated 2.2% of global deaths were a result of unsafe water sources. Time spent gathering water or seeking safe sanitation accounts for billions in lost economic opportunities. Access to safe water and sanitation at home gives families more time to pursue education and work opportunities that will help them break the cycle of poverty.

The conventional gathering of water from shallow water sources (e.g., surface water) is prone to contamination and pollution and may be dependent on current weather (e.g., rainfall, heat, etc.). The conventional bucket-and-rope system to retrieve water from underground (e.g., from a borehole or well) is prone to contamination (e.g., from unwashed hands touching the bucket and/or rope) and pollution (e.g., pollutants falling into the borehole or well). Travelling to shallow water sources and underground water sources requires much time and energy.

Installation of a hand pump may avoid water contamination and water pollution associated with conventional systems. A hand pump is operated by moving a handle, thus avoiding contamination of the water source by unwashed hands. With a hand pump, the water source (e.g., well, bore hole, etc.) is covered, thus avoiding pollutants from falling into the water source.

A wide range of organizations, such as governments, non-governmental organizations, women's groups, community groups, and the like, have been striving to provide access to clean water to groups of people throughout the world through installation of hand pumps. It is estimated that hundreds of millions of people around the world currently depend on hand pumps for water supplies. Hand pumps are also used as back-up water supplies for when other water systems (e.g., municipal water systems, electric pump-based water systems) are not operational (e.g., during power outages).

Hand pumps are mechanical systems that are prone to breaking and becoming inoperable. It is estimated that one-third to one-half of all hand pumps are inoperable at any point in time. Many hand pumps remain broken due to lack of skills, tools, and parts to repair them. While hand pumps are inoperable, people may go without water, revert to less safe water sources, and/or travel far distances to collect water.

A limited amount of water may be provided by a hand pump and local water source per day. For example, a hand pump may provide 20 liters of water per person per day. In another example, a hand pump may serve 55 households. If a hand pump or local water source is not adequate for a local population, people may go without water, revert to less safe water sources, or travel far distances to collect water.

Sensor data associated with hand pumps may be used to determine if a hand pump is in need of repair, whether preventative maintenance is to be performed, whether the hand pump is being over-used, whether additional hand pumps are to be installed, and/or the like. Sensor data associated with hand pumps can be used to minimize downtime of hand pumps (e.g., more quickly determine repair or preventative maintenance is needed and provide the repair or preventative maintenance) and to improve hand pump infrastructure (e.g., installation of additional hand pumps in a geographical region, etc.).

Collection and transmission of sensor data by a hand pump uses an energy source. Hand pumps are often located in remote locations, preventing hard-wired electrical connections to hand pumps. Even if a hard-wired electrical connection could be routed to a hand pump, the hard-wired electrical connection may be prone to damage from water, traffic, digging, and the like. Hard-wired electrical connections may also be dangerous and prone to causing injury to users. Use of disposable batteries in a hand pump would include regular replacement of the disposable batteries which involves a cost of batteries and manpower. Premature replacement of batteries is an increased cost of batteries and manpower. Allowing the batteries to completely lose their charge before replacement allows for a period of time when sensor data is not transmitted (e.g., repair, preventative maintenance, and infrastructure improvement cannot be determined).

Energy harvesters derive energy from ambient sources. Conventional energy harvesters include solar energy harvesters and wind energy harvesters. Solar energy harvesters are used to convert solar energy (e.g., direct sunlight) into electrical energy. Wind energy harvesters are used to convert wind energy into electrical energy. Conventional energy harvesters have components (e.g., solar panel, wind turbine, etc.) that may easily become damaged and/or may cease to function. For example, a solar panel may be blocked (e.g., by clouds, vegetation, buildings, or the like), a solar panel may become soiled (e.g., by bird droppings, by mud, etc.), a solar panel may be damaged (e.g., a broken panel, an old panel, water damage, etc.), or the like. In another example, a wind turbine may become blocked (e.g., by debris, feathers, insects, sand, etc.), a wind turbine may become damaged (e.g., by being inadvertently hit, by tampering, by water damage, etc.), or the like. Conventional energy harvesters, such as a solar energy harvester or wind energy harvester, may be an unreliable energy source for a hand pump, causing periods of time when sensor data is not transmitted (e.g., repair, preventative maintenance, and infrastructure improvement cannot be determined).

The devices, systems, and methods disclosed herein provide an energy harvesting device. The energy harvesting device may be coupled to an oscillating rotational structure, such as a handle of a hand pump. An oscillating rotational structure may move back and forth (e.g., up stroke and down stroke of handle) about an axis or center (e.g., where the handle connects to the body of the hand pump). The energy harvesting device may be configured to rotate responsive to the oscillating rotational motion of the oscillating rotational structure. The rotation of the energy harvesting device may generate energy that can be used to store and transmit sensor data associated with the oscillating rotational structure. For example, sensor data associated with a hand pump can be transmitted using energy provided by the energy harvesting device to minimize downtime of hand pumps (e.g., more quickly determine repair or preventative maintenance is needed and provide the repair or preventative maintenance) and to improve hand pump infrastructure (e.g., installation of additional hand pumps in a geographical region, etc.).

Although the present disclosure describes use of the energy harvesting device with a handle of a hand pump, the energy harvesting device may be used with other oscillating rotational structures, such as a strut of a train, an arm of an oil rig, or the like.

The energy harvesting device described in the present disclosure may include a hub structure configured to rotate about an axis. The energy harvesting device may further include a first arm and a second arm. The first arm may include a first hinge to connect a proximal end of the first arm to the hub. The first arm may further include a first weight coupled to a distal end of the first arm. The second arm may include a second hinge to connect a proximal end of the second arm to the hub. The second arm may further include a second weight coupled to a distal end of the second arm. In some embodiments, the hub structure, the first arm, and the second arm are integral to each other. In some embodiments, the hub structure, the first arm, and the second arm are separate pieces coupled together (e.g., with a spring, a pin, a separate hinge, or the like). In some embodiments, the first arm and the second arm are coupled to an outside perimeter of the hub structure, and the first hinge and the second hinge are to prevent the first arm and the second arm, respectively, from deflecting from being normal to the first axis of rotation.

One or more of the hub, the first arm, the second arm, the first weight, the second weight, the first hinge, the second hinge, and/or any combination thereof can derive all or part of its motion from the elasticity (e.g., flexibility) of the material from which it is made. These mechanisms are often called compliant mechanisms. A compliant mechanism may transfer or transform motion, force, or energy. A compliant mechanism may gain at least some of its mobility from the deflection of elastic (e.g., flexible) members rather than from movable joints only (e.g., some energy from input force is stored in form of strain energy in the elastic members). In some embodiments, all parts or substantially all parts of the energy harvesting device may be made from a compliant mechanism. A compliant mechanism may be made from an elastic material, a flexible material, a springy material, or the like. The material used to manufacture the energy harvesting device may directly affect the design geometry of the energy harvesting device used for the energy harvesting device to operate for extended periods of time without failure. Materials to fabricate compliant mechanisms can include metals (e.g., steels and stainless steels due to their fatigue limit, metals with fatigue limits similar to those of steels and/or stainless steels, etc.), plastics, silicon, rubber, or the like. For displacement driven designs where the energy harvesting device is to undergo a defined displacement, the design principle may be to make the compliant portion (e.g., hinges) thinner to reduce the maximum stress. A compliant material of the energy harvesting device (e.g., hinges) may be made out of metals or brittle materials (e.g., by following design guidelines).

In some embodiments, the hinge may be an elastic material (e.g., a compliant mechanism) to store energy (e.g., potential energy) in order to produce a motion by catapulting in a forward direction (e.g., in a direction of rotation of the hub) at a threshold point. Additionally or alternatively, the arm may be an elastic material (e.g., a compliant mechanism) to store energy in order to produce a motion by catapulting in a forward direction a threshold point. The elastic material may be referred to as a compliant material (e.g., a compliant energy harvesting device). A compliant energy harvesting device may referred to as an energy harvesting device that is constructed, partially or entirely, with compliant mechanisms. Use of compliant hinges and compliant mechanisms for construction of the energy harvesting device may reduce part count, simplify the production process, and decrease the cost to manufacture. Compliant mechanisms can allow for precise motion by eliminating backlash and wear, since the energy harvesting device can be constructed with no (or fewer) interconnecting pieces. Vibration and noise caused by moving joints of rigid-body mechanisms can be reduced or eliminated with compliant mechanisms. Further, compliant mechanisms are easily scalable to different sizes.

In some embodiments, the hinge may have protrusions to prevent deflections of the arm in one or more directions. In other embodiments, the hinge may have a pin to rotationally couple the arm to the hub structure. In some embodiments, the arm may have a backstop proximate to the hinge to contact the hub structure. In some embodiments, the hub structure may have a recess to receive a portion of the arm.

In some embodiments, the energy harvesting device includes a ratcheting device coupled to a central portion of the hub structure in order to allow the hub structure to rotate in one direction and to prevent the hub structure from rotating in an opposite direction. In various embodiments, the energy harvesting device may have one arm, two arms, three arms, four arms, five arms, or any number of arms, spaced equally or unequally around the hub structure.

The energy harvesting device is to be coupled to an energy generator (such as a back-driven DC motor, an AC alternator, or the like) via a shaft which may include a gear box for obtaining necessary rotational speeds for the generator to generate power. The hub structure may include a central portion configured to rotationally couple the energy harvesting device to an oscillation rotational structure. The energy generator may be coupled to a battery that can be charged by the energy generator, responsive to a rotation of the energy harvesting device. The energy harvesting device may be further coupled to a sensor to provide sensor data. A wireless module may be coupled to the battery and powered by the battery. A processing device may be coupled to the sensor, the wireless module, and the battery, and may be configured to receive the sensor data and to transmit the sensor data via the wireless module. The sensor may be an accelerometer, a strain gauge, a water or humidity sensor, a proximity sensor, a battery level sensor, or the like. The sensor data may include oscillation rotational measurements, battery level information, water or humidity level information, or the like. In some embodiments the sensor data may be used to perform structural health monitoring.

The energy harvesting device may be coupled to an oscillation rotational structure. The energy harvesting device may be configured to rotate around a first axis of rotation. The oscillation rotational structure may be configured to perform oscillating rotational motion relative to a second axis of rotation that is parallel to the first axis of rotation. The oscillation rotational structure may be a handle of a hand pump, an arm of an oil rig, a train strut, or the like.

In some embodiments, an energy harvesting device may power a transmitter, a receiver, a sensor (e.g., a temperature sensor, a proximity sensor, an acoustic sensor, an optical sensor, a tactile sensor, an electric sensor, a magnetic sensor, a moisture sensor, a pressure sensor, a force sensor, a speed sensor, or the like), a sensor network (e.g., a network of sensors in a house, a building, or the like), a mobile device, or any other suitable low-power consumption device. The devices, systems, and methods disclosed herein have advantages over conventional solutions. The energy harvesting device may be able to harvest energy by converting rotational kinetic energy into electrical energy. The rotational kinetic energy may be provided by an external source (e.g., a person operating a handle of a hand pump, an oil rig operating an arm of the oil rig, a train with a train strut or the like) and converted into electrical energy. The energy harvesting device may provide electrical energy using potential energy stored by the hinges or compliant mechanisms when the energy harvesting device is rotating. The energy harvesting device may transmit and/or receive sensor data, minimizing downtime of and providing for improvement of connected systems, such as hand pumps. Minimizing down time of and providing for improvement of hand pumps may allow access to clean water for many users around the globe.

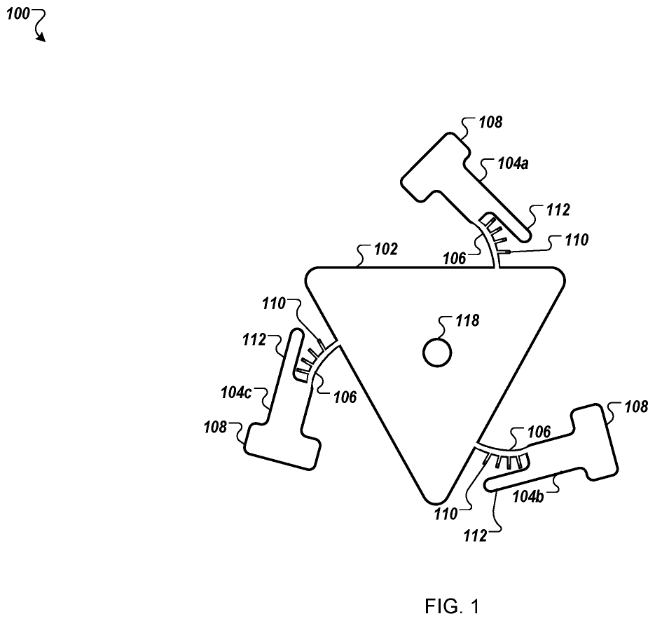

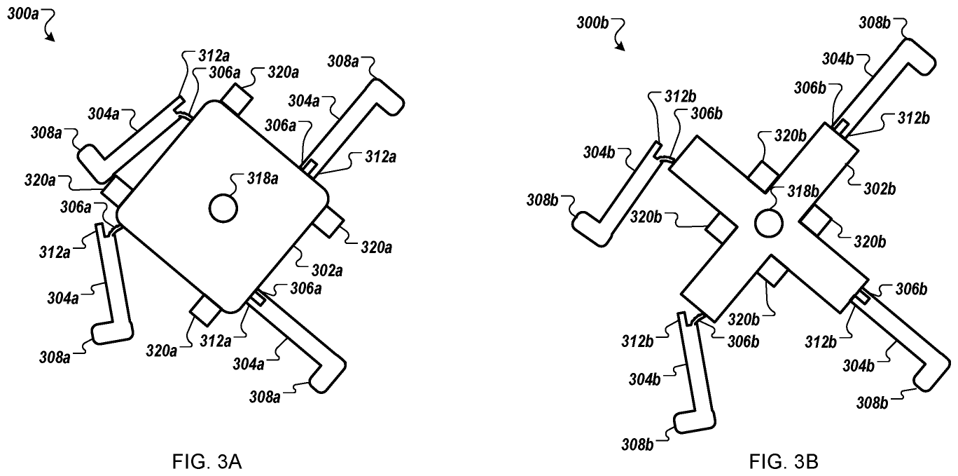

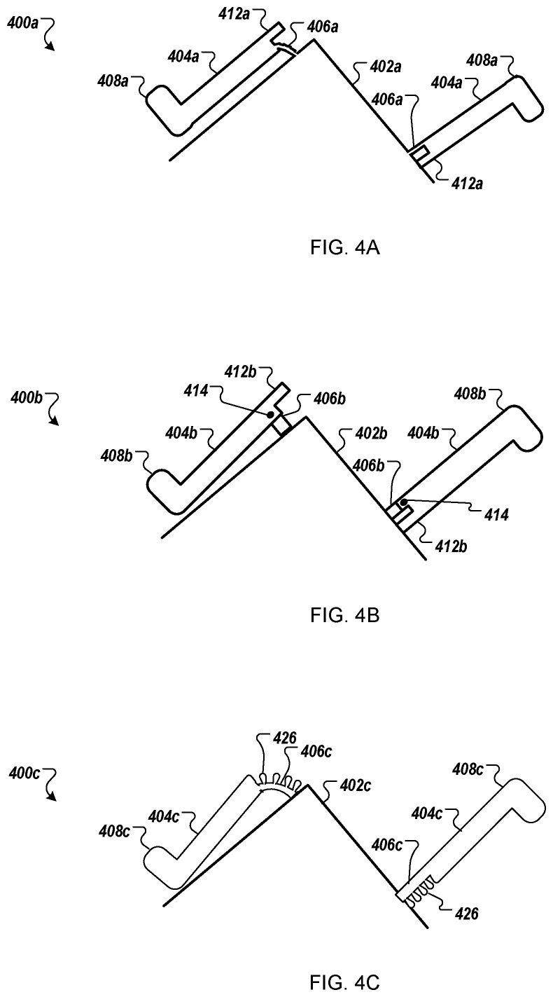

FIG. 1 illustrates an energy harvesting device 100, according to certain embodiments. The energy harvesting device 100 may be configured to convert rotational kinetic energy into electric energy. In some embodiments, the energy harvesting device 100 includes one or more compliant materials (e.g., is a compliant energy harvesting device). The energy harvesting device 100 includes a hub structure 102. The energy harvesting device 100 further includes arms 104 (e.g., arms 104a-c) coupled to an outside perimeter of the hub structure 102. Although three arms are illustrated, the energy harvesting device 100 may have any number of arms (e.g., two or more arms). The arms 104 may be equally spaced. The arms 104 may be substantially the same size or the same size. Each arm 104 may include a hinge 106 and a weight 108. Each hinge 106 may connect a proximal end of a corresponding arm 104 to the hub structure 102. Each weight 108 may be coupled to a distal end of a corresponding arm 104. The energy harvesting device 100 may further include a ratcheting device (not shown in FIG. 1 but described in more detail in reference to FIG. 4) coupled to a central portion of the hub structure 102 to allow the hub structure 102 to rotate in a first direction (e.g., a forward direction) and to prevent the hub structure from rotating in a second direction (e.g., a backward direction) that is opposite from the first direction. When the energy harvesting device 100 is not rotating (e.g., is staying still or has no rotational kinetic energy) the arms 104 may be positioned in a first position (e.g., an undeflected position, see FIGS. 3A-B). All or any combination of the hub structure 102, the arms 104, the hinges 106, and/or the weights 108 may be compliant mechanisms.

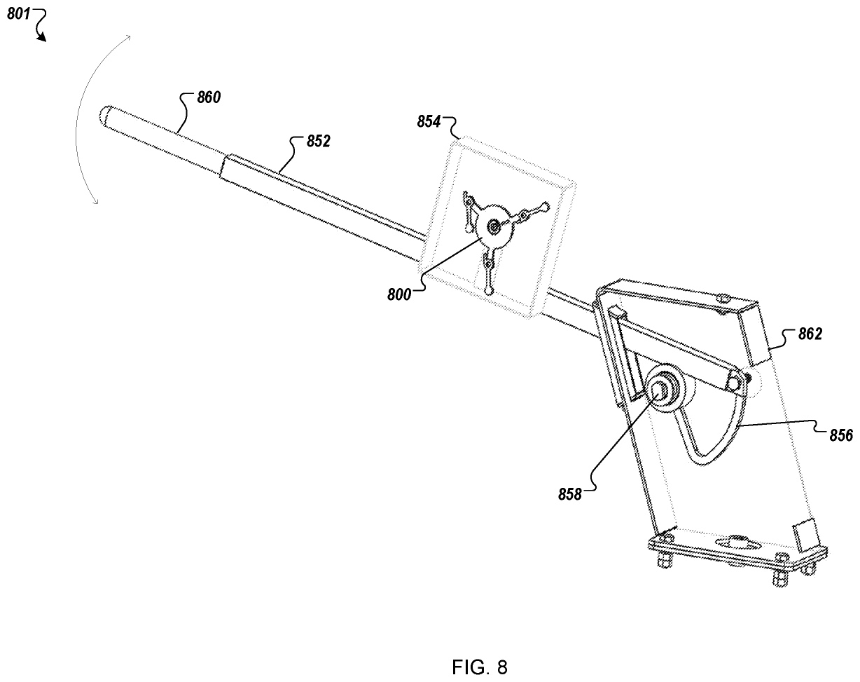

The energy harvesting device 100 may be configured to couple to an oscillation rotational structure, such as a handle of a hand pump, an arm of an oil rig, a train strut, or the like. The energy harvesting device 100 may be caused to rotate (e.g., have finite rotational kinetic energy) in response to a motion of the oscillation rotational structure (e.g., an oscillation of the oscillation rotational structure about a fixed point). The energy harvesting device 100 may be designed to rotate in a first direction about a first axis of rotation located at a center 118 of a planar surface of the hub structure 102. The oscillation rotational structure may be caused to have oscillatory motion by an external force, and may be caused to rotate around a second axis of rotation (e.g., of the oscillation rotational structure), parallel to the first axis of rotation (e.g., of the energy harvester). The second axis of rotation may be a point at which the oscillation rotational structure is fixed, such that the oscillation rotational structure may rotate about the point (e.g., the point at which the handle of a hand pump is fixed to the hand pump itself). Note that the oscillation rotational structure is not shown in FIG. 1, and will be discussed in further detail in reference to FIGS. 8-10B.

When the energy harvesting device 100 rotates in a first direction, each arm 104 may be deflected (e.g., rotated) in a second direction (opposite to the first direction) around a corresponding axis of rotation located at the corresponding hinge and parallel to the first axis of rotation and the second axis of rotation. The hinges 106 may be compliant mechanisms to store energy while the hub rotates in order to produce a motion by catapulting the weights 108 in the first direction (e.g., in the forward direction) at a threshold point. The threshold point may be a second position (e.g., a deflected position) of the arms when the hinges cause the arms to return to the first position (the undeflected position). When the weights 108 are catapulted in the forward direction, they may produce the rotation of the hub structure 102.

In some embodiments, the hinges 106 may be a compliant mechanism (e.g., made from a flexible material, an elastic material, a springy material, or the like). A compliant mechanism may be fabricated from planar sheets of material or may be an injection-molded material or the like. The compliant mechanism fabricated from planar sheets may be cut out using a water jet, laser, wire electrical discharge machining (EDM), plasma cutter, or the like. Materials used to fabricate compliant mechanism from planar sheets may include low alloy steels, stainless steels, titanium, aluminum, or the like. Materials used to fabricate compliant mechanisms using injection or other molding may include plastic, silicon, rubber, or the like. A compliant mechanism may be a mechanism that gains at least some of its mobility from deflection of flexible members rather than from movable joints only.

When the energy harvesting device rotates in the first direction, the arms 104 may be caused to change positions from the undeflected position, to the deflected position, or to some position between the deflected position and undeflected position. In the depicted embodiment, the hinges 106 may have protrusions 110 (also referred to as “fingers” herein) to prevent deflections of the hinges 106 in directions not perpendicular to the axis of rotation.

In one embodiment, the hub structure 102 and the arms 104 are integral to each other. In other embodiments, the hub structure 102, the arms 104, and the weights 108 are integral to each other. In one embodiment, the arms 104 include backstops 112 proximate to the hinges 106 to contact the hub structure 102. The backstops 112 may prevent the arms from deflecting from the undeflected position to a deflected position in the forward direction (e.g., first direction). In some embodiments, the hub structure 102 may have a rounded triangle shape. In the depicted embodiment, the energy harvesting device 100 has three arms, disposed in an equally spaced pattern on the hub structure 102. In other embodiments, the energy harvesting device 100 may have more than three arms, such as four arms, five arms, six arms, or the like. In some embodiments, the more than three arms may be disposed in an equally spaced pattern on the hub structure 102. In other embodiments, the three arms or the more than three arms may be disposed in a non-equally spaced pattern on the hub structure 102. The hub structure may be square shaped, disk shaped, circular shaped, triangle shaped, cross shaped, pentagon shaped, or the like. The hub structure may have holes throughout in order to make the hub structure lighter. Alternatively, the hub structure may be solid in order to make the hub structure heavier.

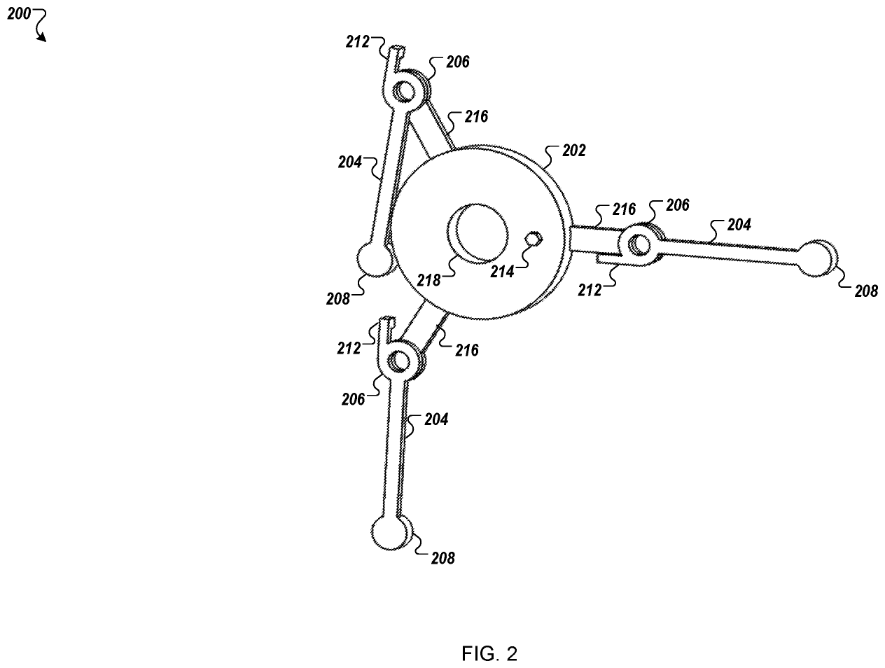

FIG. 2 illustrates an energy harvesting device 200 including standoffs 216, arms 204, and a hub structure 202, according to certain embodiments. In some embodiments, the standoffs 216 are connected to the hub structure 202 by pins 214. In other embodiments, the standoffs 216 may be integral to the hub structure 202. The energy harvesting device 200 is configured to convert oscillating rotational motion (e.g., rotational kinetic energy) into electric energy. The energy harvesting device 200 and components of the energy harvesting device 200 may be similar to the energy harvesting device 100 and components of the energy harvesting device 100, as noted by similar reference numbers. The energy harvesting device 200 includes a hub structure 202. In some embodiments, the hub structure 202 is cylindrical (e.g., disk-shaped) forming a hole 218 at the center of the hub structure 202 (e.g., for coupling the hub structure 202 to a shaft). Each standoff 216 may be coupled to the hub structure 202. Each arm 204 may be coupled to a standoff 216 by a hinge 206. The standoffs 216 may allow further rotational motion of the arms. The hinges 206 may be torsion springs. A weight 208 may be coupled to each arm 204. In some embodiments, weight 208 and arm 204 may be a single integrated component. In some embodiments, weight 208 and arm 204 may be separate components. In some embodiments, the energy harvesting device 200 has three arms 204, disposed in an equally spaced pattern on the hub structure 202. In some embodiments, the energy harvesting device 200 may have two or more arms 204, such as two arms, four arms, five arms, six arms, or the like. In some embodiments, the two or more arms 204 may be disposed in an equally spaced pattern on the hub structure 202. In some embodiments, the two or more arms 204 may be disposed in a non-equally spaced pattern on the hub structure 202.

When the energy harvesting device 200 is placed in a horizontal configuration and is not rotating (e.g., is staying still or has no rotational kinetic energy) the arms 204 are positioned at a first position (e.g., an undeflected position). When the energy harvesting device is placed in any configuration besides the horizontal configuration (such as vertically or at an angle) and is not rotating, some or all of the arms may be deflected by a gravitational acceleration such that the first position is slightly deviated from the undeflected position. All or any combination of the hub structure 202, the arms 204, the hinges 206, the weights 108, or the pins 214 may be compliant mechanisms.

The energy harvesting device 200 may be coupled to an oscillation rotational structure such as a handle of a hand pump, an arm of an oil rig, a train strut, or the like. In some embodiments, the energy harvesting device 200 is connected (e.g., rotationally connected, rotationally coupled) to an energy generator (e.g., that is coupled to an oscillation rotational structure). In some embodiments, the energy harvesting device 200 is connected to an oscillation rotational structure. In some embodiments, the energy harvesting device 200 is connected to an energy generator and an oscillation rotational structure. The energy harvesting device 200 may be caused to rotate (e.g., have finite rotational kinetic energy) in response to a motion of the oscillation rotational structure. The energy harvesting device 200 may be designed to rotate in a first direction about a first axis of rotation located at a center (e.g., the hole 218) of a planar surface of the hub structure 202, and which is perpendicular to the planar surface of the hub structure 202. The oscillation rotational structure may be caused to have oscillatory motion by an external force, and may be caused to rotate around a second axis of rotation, parallel to the first axis of rotation. The second axis of rotation may be a point at which the oscillation rotational structure is fixed, such that the oscillation rotational structure may rotate about the point (e.g., the point at which the handle of a pump is fixed to the pump itself). Note that the oscillation rotational structure is not shown in FIG. 2, and will be discussed in further detail in reference to FIGS. 8-10B.

When the energy harvesting device rotates in the first direction, the arms 204 may be deflected (e.g., rotated) in the second direction, opposite to the first direction, around an axis of rotation, located at the corresponding hinges 206, and parallel to the first axis of rotation and the second axis of rotation. In one embodiment, the hinges 206 may be compliant mechanisms to store energy while the hub rotates in order to produce a motion by catapulting the weights 208 in the first direction (e.g., in the forward direction) at a threshold point. In another embodiment, the hinges 206 may be springs (e.g., torsion springs) to store energy while the hub rotates in order to produce a motion by catapulting the weights 208 in the first direction (e.g., in the forward direction) at a threshold point. In another embodiment, the hinges 206 may not include any springs. In another embodiment, the hinges 206 may be compliant mechanisms combined with springs. The threshold point may be a second position (e.g., a deflected position) of the arms when the hinges cause the arms to return to the first position (the undeflected position). When the weights 208 are catapulted in the forward direction, they may produce the rotation of the hub structure 202. In one embodiment, the arms 204 include backstops 212 proximate to the hinges 206 to contact the hub structure 202. The backstops 212 may prevent the arms from deflecting from the undeflected position to a deflected position in the forward direction (e.g., first direction).

FIG. 3A illustrates an energy harvesting device 300a with bumpers 320a attached to hub structure 302a to convert rotational kinetic energy into electric energy, according to certain embodiments. The energy harvesting device 300a and components of the energy harvesting device 300a may be similar to the energy harvesting device 100 and components of the energy harvesting device 100, as noted by similar reference numbers. The energy harvesting device 300a includes a hub structure 302a. In the depicted embodiment, the hub structure 302a may be square shaped with a hole 318a in the center. Arms 304a may be coupled to the hub structure by hinges 306a. Weights 308a may be coupled to the arms 304a. In one embodiment, the weights 308a and the arms 304a may be a single integrated component. In another embodiment, the weights 308a and the arms 304a may be separate components. In the some embodiments, the energy harvesting device 300a has four arms, disposed in an equally spaced pattern on the hub structure 302a. In other embodiments, the energy harvesting device 300a may have a different number of arms, such as two arms, three arms, five arms, eight arms, or the like. In some embodiments, the different number of arms may be disposed in an equally spaced pattern on the hub structure 302a. In other embodiments, the four arms or the different number arms may be disposed in a non-equally spaced pattern on the hub structure 302a.

When the energy harvesting device harvesting device 300a is not rotating (e.g., is staying still or has no rotational kinetic energy) the arms are positioned at a first position (e.g., an undeflected position). All or any combination of the hub structure 302a, the arms 304a, the hinges 306a, the weights 108a, or the pins 314a may be compliant mechanisms.

The energy harvesting device 300a may be coupled to an energy generator which may be coupled to an oscillation rotational structure such as a handle of a hand pump, an arm of an oil rig, a train strut, or the like. The energy harvesting device 300a may be caused to rotate (e.g., have finite rotational kinetic energy) in response to a motion of the oscillation rotational structure. The energy harvesting device 300a may be designed to rotate in a first direction about a first axis of rotation located at a center (at the hole 318a) of a planar surface of the hub structure 302a, and which is perpendicular to the planar surface of the hub structure 302a. The oscillation rotational structure may be caused to have oscillatory motion by an external force, and may be caused to rotate around a second axis of rotation (e.g., at a point where the oscillation rotational structure may be fixed by a pivot point), parallel to the first axis of rotation.

When the energy harvesting device rotates in the first direction, each arm 304a may be deflected (e.g., rotated) in the second direction, opposite to the first direction, around a corresponding axis of rotation, located at the corresponding hinges 306a, and parallel to the first axis of rotation and the second axis of rotation. In one embodiment, the hinges 306a may be compliant mechanisms to store energy while the hub rotates in order to produce a motion by catapulting the weights 308a in the first direction (e.g., in the forward direction) at a threshold point. In another embodiment, the hinges 306a may be springs (e.g., torsion springs) to store energy while the hub rotates in order to produce a motion by catapulting the weights 308a in the first direction (e.g., in the forward direction) at a threshold point. In another embodiment, the hinges 306a may be compliant mechanisms combined with springs. The threshold point may be a second position (e.g., a deflected position) of the arms when the hinges cause the arms to return to the first position (the undeflected position). When the weights 308a are catapulted in the forward direction, they may cause the rotation of the hub structure 302a. In one embodiment, the arms 304a include backstops 312a proximate to the hinges 306a to contact the hub structure 302a. The backstops 312a may prevent the arms from deflecting from the undeflected position to a deflected position in the forward direction (e.g., first direction). In one embodiment, the hub structure 302a includes bumpers 320a to contact one or both of the arms 304a and/or the weights 308a. The bumpers 320a may prevent the weights 308a from contacting the hub structure 302a itself when the energy harvesting device 300a is rotating and the arms are in the second position (e.g., the deflected position). Note that the energy harvesting device 300a is depicted with backstops 312a and bumpers 320a for illustrative purposes, but an energy harvesting device, such as the energy harvesting device 300a, may perform substantially similarly without backstops and/or bumpers.

FIG. 3B illustrates an energy harvesting device 300b with recesses in hub structure 302b to convert rotational kinetic energy into electric energy, according to certain embodiments. The energy harvesting device 300b and components of the energy harvesting device 300b may be similar to the energy harvesting device 100 and components of the energy harvesting device 100, as noted by similar reference numbers. The energy harvesting device 300b includes a hub structure 302b. The hub structure 302b may form recesses, where each recess at least partially receives a corresponding arm 304. In the depicted embodiment, the hub structure 302b may be cross shaped forming a hole 318b in the center. Additionally or alternatively, the hub structure 302b may be a first square shape with second square shapes, smaller than one quarter of the first square shape, removed from each corner. Arms 304b may be coupled to the hub structure by hinges 306b. Weights 308b may be coupled to the arms 304b. In one embodiment, the weights 308b and the arms 304b may be a single integrated component. In another embodiment, the weights 308b and the arms 304b may be separate components. In the depicted embodiment, the energy harvesting device 300b has four arms, disposed in an equally spaced pattern on the hub structure 302b. In other embodiments, the energy harvesting device 300b may have a different number of arms, such as two arms, three arms, five arms, 8 arms, or the like. In some embodiments, the different number of arms may be disposed in an equally spaced pattern on the hub structure 302b. In other embodiments, the four arms or the different number arms may be disposed in a non-equally spaced pattern on the hub structure 302b.

When the energy harvesting device harvesting device 300b is not rotating (e.g., is staying still or has no rotational kinetic energy) the arms are positioned at a first position (e.g., an undeflected position). All or any combination of the hub structure 302b, the arms 304b, the hinges 306b, the weights 108b, or the pins 314b may be compliant mechanisms.

The energy harvesting device 300b may be coupled to an energy generator which may be couple to an oscillation rotational structure such as a handle of a hand pump, an arm of an oil rig, a train strut, or the like. The energy harvesting device 300b may be caused to rotate (e.g., have finite rotational kinetic energy) in response to a motion of the oscillation rotational structure. The energy harvesting device 300b may be designed to rotate in a first direction about a first axis of rotation located at a center of a planar surface of the hub structure 302a, and which is perpendicular to the planar surface of the hub structure 302a. The oscillation rotational structure may be caused to have oscillatory motion by an external force, and may be caused to rotate around a second axis of rotation, parallel to the first axis of rotation.

When the energy harvesting device rotates in the first direction, the arms 304b may be deflected (e.g., rotated) in the second direction, opposite to the first direction, around a corresponding axis of rotation, located at the corresponding hinges 306b, and parallel to the first axis of rotation and the second axis of rotation. In one embodiment, the hinges 306b may be compliant mechanisms to store energy while the hub rotates in order to produce a motion by catapulting the weights 308b in the first direction (e.g., in the forward direction) at a threshold point. In another embodiment, the hinges 306b may be springs (e.g., torsion springs) to store energy while the hub rotates in order to produce a motion by catapulting the weights 308b in the first direction (e.g., in the forward direction) at a threshold point. In another embodiment, the hinges 306b may be compliant mechanisms combined with springs. The threshold point may be a second position (e.g., a deflected position) of the arms when the hinges cause the arms to return to the first position (the undeflected position). When the weights 308b are catapulted in the forward direction, they may produce the rotation of the hub structure 302b. In one embodiment, the arms 304b include backstops 312b proximate to the hinges 306b to contact the hub structure 302b. The backstops 312b may prevent the arms from deflecting from the undeflected position to a deflected position in the forward direction (e.g., first direction). In one embodiment, the cross shape of the hub structure 302b may allow the weights 308b to be closer to the first axis of rotation when the arms 304b are in the deflected (second) position compared to the deflected position of the energy harvesting devices 100, 200, or 300a. By allowing the weights 308b to be closer to the first axis of rotation when the arms 304b are in the deflected (second) position (e.g., when the energy harvesting device 300b is rotating), an opposing moment of inertia of the energy harvesting device 300a may be reduced. This may provide an additional benefit by allowing more of the angular kinetic energy caused by the arms 304b catapulting the weights 308b in the first direction to go directly into driving the generator (e.g., energy generator, back driven DC motor, AC alternator, etc.). In some embodiments the energy harvesting device 300b may include bumpers 320b to contact one or both of the arms 304b or the weights 308b. The bumpers 320b may prevent the weights 308a from contacting the hub structure 302a when the energy harvesting device 300b is rotating and the arms are in the second position (e.g., the deflected position). Note that the energy harvesting device 300b is depicted with backstops 312b and bumpers 320b for illustrative purposes, but an energy harvesting device, such as the energy harvesting device 300b, may perform substantially similarly without backstops and/or bumpers.

FIGS. 4A-4C illustrate three energy harvesting devices 400a-c with different configurations of arms and hinges according to various embodiments. Although not all components of the energy harvesting device 100 are shown, the energy harvesting devices 400a-c are similar to the energy harvesting device 100 of FIG. 1 as noted by similar reference numbers. FIG. 4A illustrates an energy harvesting device 400a formed from a single piece of material according to certain embodiments. In one embodiment, hub structure 402a, arms 404a, hinges 406a, backstops 412a, and weights 408a may be made of a single piece of compliant material. The hinges 406a may be complaint mechanisms to position the arms 404a in a first position (e.g., an undeflected position) when the energy harvesting device 400a is not rotating. When the energy harvesting device 400a rotates in a first direction about a first axis of rotation, at the center of the hub structure 402a, the arms 404a may be deflected (e.g., rotated) in a second direction, opposite to the first direction located at the corresponding hinges 406a, and parallel to the first axis of rotation. The hinges 406a may be compliant mechanisms to store energy while the hub structure 402a rotates in order to produce a motion by catapulting the weights 408a in the first direction (e.g., in the forward direction) at a threshold point.

FIG. 4B illustrates an energy harvesting device 400b with standard hinges 406b according to certain embodiments. In one embodiment, hub structure 402b may be made of a first material. Arms 404b and backstops 412b may be made of a second material. Weights 408b may be made of a third material. In some embodiments the arms 404b, the backstops 412b, and the weights 408b may be a single integrated piece. In other embodiments, the arms 404b and the weights 408b may be separate pieces coupled together. In some embodiments the first material, the second material, and the third material may be the same material. In other embodiments, the first material, the second material, and the third material may be different materials. In other embodiments, two of the first material, the second material, and the third material may be the same material. Pins 414 may be to couple the arms 404b to the hub structure 402b to form the hinges 406b. The hinges 406b may include a spring (e.g., a torsion spring) to position the arms 404b in a first position (e.g., an undeflected position) when the energy harvesting device 400b is not rotating. When the energy harvesting device 400b rotates in a first direction about a first axis of rotation, at the center of the hub structure 402b, the arms 404a may be deflected (e.g., rotated) in a second direction, opposite to the first direction located at the corresponding hinges 406b, and parallel to the first axis of rotation. The hinges 406b may be compliant mechanisms to store energy while the hub structure 402b rotates in order to produce a motion by catapulting the weights 408b in the first direction (e.g., in the forward direction) at a threshold point.

FIG. 4C illustrates an energy harvesting device 400c with hinges 406c with protrusions (e.g., fingers or projections), according to certain embodiments. The hinges 406c may be compliant mechanisms to position the arms 404c in a first position (e.g., an undeflected position) when the energy harvesting device 400c is not rotating. When the energy harvesting device 400c rotates in a first direction about a first axis of rotation, at the center of the hub structure 402c, the arms 404c may be deflected (e.g., rotated) in a second direction, opposite to the first direction located at the corresponding hinges 406c, and parallel to the first axis of rotation. The hinges 406c may be compliant mechanisms to store energy while the hub structure 402c rotates in order to produce a motion by catapulting the weights 408c in the first direction (e.g., in the forward direction) at a threshold point. Each hinge 406c may include a plurality of protrusions 426. The protrusions 426 may be integrated with the hinge 406c as a single piece. The protrusions 426 may allow the arms to rotate in the first direction and the second direction and may prevent the arms 404c from rotating out of a plane of a surface of the hub structure 402c (e.g., in a direction perpendicular to the first direction and the second direction). Preventing the arms 404c from rotating in the direction perpendicular to the first direction and the second direction, may reduce a risk of breaking (e.g., decoupling) the arms 404c off of the hub structure 402c.

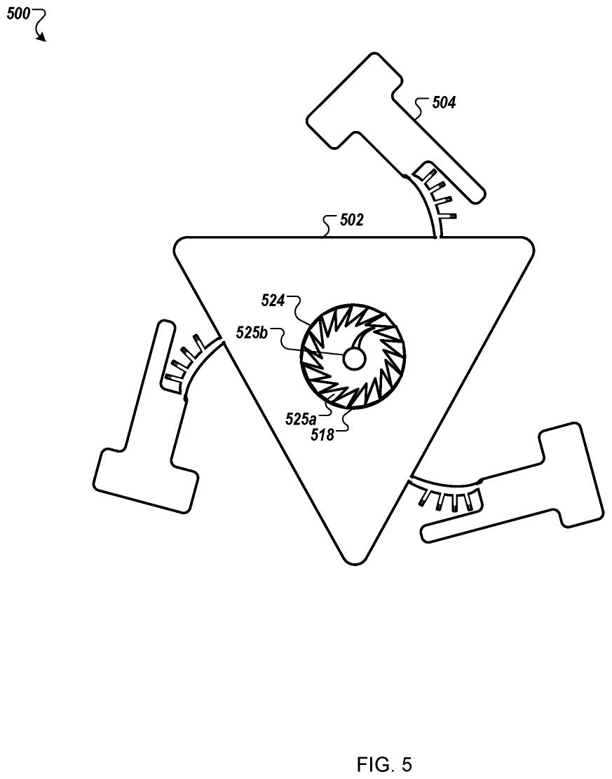

FIG. 5 illustrates an energy harvesting device 500 with a ratcheting structure 524 on a hub structure 502, according to certain embodiments. Although not all components of the energy harvesting device 100 are shown, the energy harvesting device 500 is similar to the energy harvesting device 100 of FIG. 1 as noted by similar reference numbers. The ratcheting structure 524 may be disposed in a hole 518 located at a center of the hub structure 502. In some embodiments, the ratcheting structure 524 is integral to a shaft running through the center hole 518. In other embodiments the ratcheting structure 524 is separate from the shaft and is integral to the hub structure 502. The ratcheting structure 524 may allow the energy harvesting device 500 to rotate in a first direction (forward direction, e.g., clockwise in FIG. 5) about a first axis of rotation of the hub structure 502 and may prevent the energy harvesting device 500 from rotating in a second direction (backwards direction, e.g., counter clockwise or anti-clockwise in FIG. 5), opposite from the first direction.

In one embodiment, the ratcheting structure 524 may include ratchet wheel 525a (e.g., a round gear, a saw tooth wheel with uniform but asymmetrical teeth) and pawl 525b (for example, a spring-loaded, hooked rod or a click). In one embodiment, the pawl 525b may be disposed at a center of the hole 518. The ratchet wheel 525a may be disposed on an edge of the hole 518 with teeth facing inward (e.g., towards a center of the hole 518) asymmetrically so as to allow rotation of the hub structure 502 in the first direction and prevent rotation of the hub structure 502 in the second direction. In another embodiment (not illustrated in FIG. 5), the pawl 525b may be fixed to the edge of the hole 518 and the ratchet wheel 525a may be disposed in the center of the hole 518. A center of the ratchet wheel 525a may be located on the first axis of rotation of the hub structure 502. In another embodiment, a one-way clutch bearing may be used to prevent rotation in the backward direction.

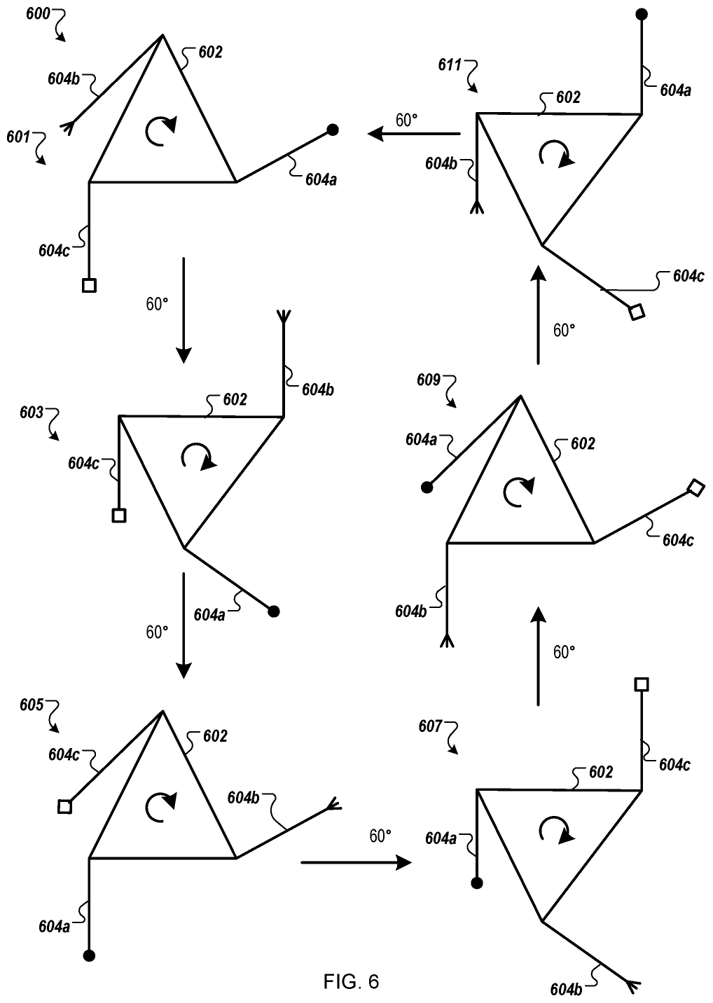

FIG. 6 shows an energy harvesting device 600 at various instances of rotation, according to certain embodiments. In the depicted embodiment, the energy harvesting device is rotating in a first direction (e.g., a forward direction or a clockwise direction) about a first axis of rotation through the center of hub structure 602 and perpendicular to a plane of the hub structure 602. It should be noted that the energy harvesting device may be configured to rotate in a counter clockwise direction in other embodiments. Arm 604a is coupled to the hub structure 602 via a first hinge (not shown in FIG. 6). The first hinge is to apply a first torque in the first direction on the arm 604a, about an axis of rotation of the arm 604a. The axis of rotation of the first arm 604a may be at the first hinge and parallel to the first axis of rotation. Arm 604b is coupled to the hub structure 602 via a second hinge (not shown in FIG. 6). The second hinge is to apply a second torque in the first direction on the arm 604b, about an axis of rotation of the arm 604b. The axis of rotation of the arm 604b may be at the second hinge and parallel to the first axis of rotation. Arm 604c is coupled to the hub structure 602 via a third hinge (not shown in FIG. 6). The third hinge is to apply a third torque in the first direction on the arm 604c, about an axis of rotation of the arm 604c. The axis of rotation of the arm 604c may be at the third hinge and parallel to the first axis of rotation. Note that the first hinge, the second hinge, and the third hinge may be compliant hinges, springs, conventional hinges, or the like. In some embodiments, the first hinge, the second hinge, and the third hinge may be any of the hinges 106 of FIG. 1, 206 of FIG. 2, 306a of FIG. 3A, 306b of FIG. 3B, 406a of FIG. 4A, 406b of FIG. 4B, or 406c of FIG. 4C. When the energy harvesting device is rotating, an acceleration in the first direction may cause a torque in the second direction on the arms 604a, 604b, and 604c about the axes of rotation of the arms 604a, 604b, and 604c, respectively. In some embodiments, the energy harvesting device may be oriented such that a gravitational acceleration exerts a varying torque in the first direction or the second direction on the arms 604a, 604b, and 604c based on a rotational orientation of the energy harvesting device. In other embodiments, the energy harvesting device may be oriented such that the gravitational acceleration exerts the same torque in a direction perpendicular to the first direction and the second direction, regardless of the rotational orientation of the energy harvesting device.

At a first instance 601 of the rotation of the energy harvesting device, the arm 604a may be in a first position (e.g., a fully extended position or an undeflected position). The first position may be when an arm is at a first angle from a side of the hub structure. In some embodiments, the first angle is less than 90°. In some embodiments, the first angle is about 90°. In some embodiments, the first angle is about 90° to about 180°. In some embodiments, the first angle is less than 180°. The arm 604b may be in a second position (e.g., a fully retracted position, a deflected position, or a fully deflected position). The second position may be when an arm is at a second angle, less than the first angle from the side of the hub structure. The second position may be the threshold point at which a weight is catapulted forward (e.g., in the first direction) by energy stored by the compliant hinge in order to produce a motion (e.g., a rotation of the energy harvesting device in the first direction). The arm 604c may be in the first position. At a second instance 603 of the rotation, the energy harvesting device may have rotated in the first direction by 60°. At the second instance 603, the arm 604a may be in the first position, the arm 604b may be in the first position, and the arm 604c may be in a position between the first position and the second position (e.g., a partially extended position, a partially retracted position, a partially deflected position, or the like). The position between the first position and the second position may be when an arm is at an angle between the first angle and the second angle. At a third instance 605 of the rotation, the energy harvesting device may have rotated in the first direction by an additional 60° compared to the second instance. At the third instance 605, the arm 604a may be in the first position, the arm 604b may be in the first position, and the arm 604c may be in the second position. At a fourth instance 607 of the rotation, the energy harvesting device may have rotated in the first direction by an additional 60° compared to the third instance. At the fourth instance 607, the arm 604a may be in the position between the first position and the second position, the arm 604b may be in the first position, and the arm 604c may be in the first position. At a fifth instance 609 of the rotation, the energy harvesting device may have rotated in the first direction by an additional 60° compared to the fourth instance. At the fifth instance 609, the arm 604a may be in the second position, the arm 604b may be in the first position, and the arm 604c may be in the first position. At a sixth instance 611 of the rotation, the energy harvesting device may have rotated in the first direction by an additional 60° compared to the fifth instance. At the sixth instance 611, the arm 604a may be in the first position, the arm 604b may be in the first position, and the arm 604c may be in the position between the first position and the second position. An additional 60° rotation in the first direction may cause the energy harvesting device to return to the first instance of rotation.

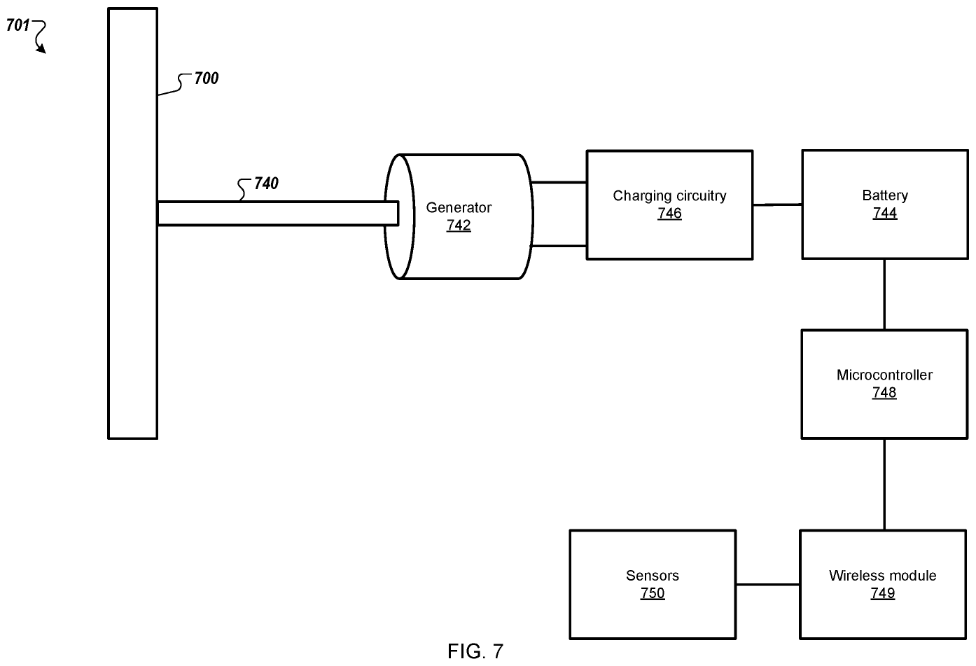

FIG. 7 illustrates an energy harvesting system 701 with an energy harvesting device 700 according to certain embodiments. The energy harvesting device 700 depicted in FIG. 7 is a side view of an energy harvesting device as described herein, such as energy harvesting device 100 of FIG. 1, energy harvesting device 200 of FIG. 2, energy harvesting device 300a of FIG. 3A, energy harvesting device 300b of FIG. 3B, and the like. The energy harvesting device 700 may be coupled to a first distal end of a shaft 740 (e.g., a rod, or the like). A second distal end of the shaft 740 may be coupled to an energy generator 742 (e.g., an electrical energy generator such as a back-driven DC motor, AC alternator, or the like). The generator may or may not include a gear box for transforming the rotational input speed to a rotational speed necessary for power generation with the given motor. The energy harvesting device 700 may rotate in a first direction about a first axis of rotation along the shaft 740 responsive to an externally generated oscillating rotational motion. The shaft 740 may rotate in the first direction about the first axis of rotation responsive to the rotation of the energy harvesting device 700, and may drive the energy generator. The rotation of the energy harvesting device 700 may be a result of the externally generated oscillating rotational motion. The rotation of the energy harvesting device 700 may further be a result of a catapulting of weights of the energy harvesting device by energy stored by compliant hinges (compliant mechanisms) during the rotation of the energy harvesting device 700. The energy generator 742 generates electrical energy responsive to the shaft 740 driving the energy generator 742. In one embodiment, the energy generator 742 may be coupled to battery 744 (e.g., via a circuit or circuitry to regulate the battery 744). In some embodiments, the battery may store energy to power a device, such as a sensor, a microcontroller, a wireless module, a processing device, or the like. In some embodiments, the energy generator 742 may directly power a device such as a sensor, a microcontroller, a wireless module, a processing device, a cellular chip, or the like. The sensor may be an accelerometer, a strain gauge, a water or humidity sensor, a proximity sensor, a battery level sensor, or the like. A speed at which the energy generator 742 is driven may be proportional to an amount of energy generated by the energy generator 742. The speed at which the energy generator 742 is driven may directly depend on a speed at which the energy harvesting device 700 rotates. The speed at which the energy harvester device 700 rotates may determine the amount of energy generated by the energy generator (e.g., a faster speed of rotation may result in a greater energy generation).

In some embodiments, the energy harvesting device 700 may be coupled to a sensor 750 to provide sensor data. A wireless module 749 may be coupled to the battery 744 and may be powered by the battery. A processing device 748 may be coupled to the sensor 750, the wireless module 749 (such as a wireless transmitter or wireless receiver), and the battery 744, and may be configured to receive the sensor data and to transmit the sensor data via the wireless module 749. The sensor 750 may be an accelerometer, a strain gauge, a water or humidity sensor, a proximity sensor, a battery level sensor, or the like. The sensor data may include oscillation rotational measurements, battery level information, water or humidity level information, or the like. A circuit 746 may be coupled between the energy generator 742 and the battery 744 and may be configured to charge the battery responsive to the energy generator 742 generating electrical energy.

FIG. 8 illustrates a system 801 including an energy harvesting device 800 coupled to an oscillation rotational structure 852 according to certain embodiments. It should be noted that components of system 801 may not be drawn to scale, and in some embodiments, the energy harvesting device 800 may be larger or smaller than shown. A rotational oscillation motion of the oscillation rotational structure 852 may cause the energy harvesting device 800 to rotate about a first axis of rotation. The first axis of rotation may be located at a center of the energy harvesting device 800. The oscillation rotational structure may be a lever (e.g., a pole, a stick, a rod, a shaft, a handle of a hand pump, or the like) coupled by a pivot point 858 to a fixed structure, such as a hand pump. The pivot point 858 serves as an axis of rotation (e.g., a second axis of rotation) of the oscillation rotational structure. The second axis of rotation may be parallel to the first axis of rotation. The second axis of rotation and the first axis of rotation may be perpendicular to a plane formed by the rotational oscillation motion of the oscillation rotational structure 852. The energy harvesting device 800 may be housed in a case 854 (e.g., a housing, a box, a cover, or the like) coupled to the oscillation rotational structure 852. The case 854 may provide protection for the energy harvesting structure 800 from theft, destruction, weather, elements, or the like. In one embodiment, the oscillation rotational structure is a handle of a hand pump. In other embodiments, the oscillation rotational structure may be an arm of an oil rig, a train strut of a train or the like. In order to provide rotational oscillation, the oscillation rotational structure may be powered or driven by an external source. For example, the handle of the hand pump may be operated by a person using the hand pump, the arm of the oil rig may be operated by a motor driving the oil rig, the train strut of the train may be driven by the train, or the like. The rotational oscillation may be a motion that causes the energy harvesting device 800 to move in a periodic way (e.g., back and forth, up and down, forward and backward, or the like) on an arc of a curve. The curve may be defined by a circle, an ellipse, a mathematical function, a standard curve, or the like. The energy harvesting device may be coupled to the oscillation rotational structure at a position along the oscillation rotational structure that is a finite distance from the axis of rotation of the oscillation rotational structure. The position of the energy harvesting device along the oscillation rotational structure may determine an amplitude of the rotational oscillation experienced by the energy harvesting device 800. For example, in the case of rotational oscillation along an arc of a circle, a position of the energy harvesting device that is farther away from the axis of rotation of the oscillation rotational structure leads to a larger amplitude of rotational oscillation. A larger amplitude of rotational oscillation may lead to a greater amount of energy harvested by the energy harvesting device.

In the depicted embodiment, the energy harvesting device 800 is coupled to the oscillation rotation structure 852. A first end 856 of the oscillation rotation structure 852 may be coupled to an immobile structure 862 (such as a pump structure fixed to the ground, an oil rig fixed to the ground, a train, a wall, or the like). The point of coupling may be a pivot point 858 to form the axis of rotation of the oscillation rotation structure 852. A force (e.g., an applied force) may be exerted on a second end 860 of the oscillation rotational structure to cause a torque about the axis of rotation to be applied to the oscillation rotational structure 852. The oscillation rotational structure may alternatingly rotate about the axis of rotation and cause the energy harvesting device 800 rotate about an axis of its hub structure.

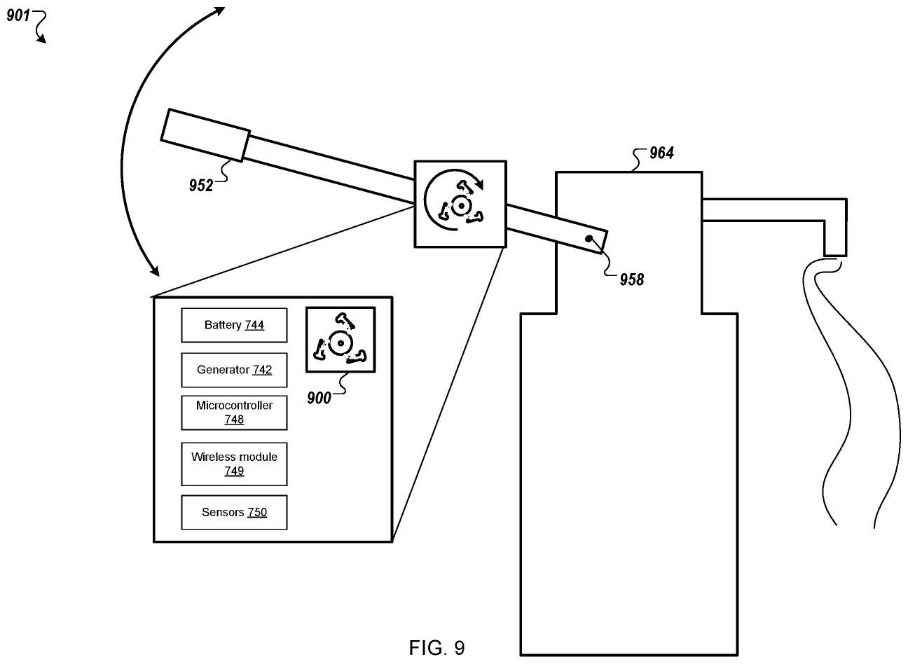

FIG. 9 is system 901 including a hand pump 964 with an energy harvesting device 900 coupled to a pump handle 952 of a hand pump 964, according to certain embodiments. The hand pump 964 can be one or more of a suction hand pump, a piston hand pump, a plunger hand pump, a hand-pull pump, or the like. Though depicted and a described as a water pump in the following description relating to FIG. 9, it should be noted that the hand pump 964 can be used to pump a gas or liquid, such as an air pump, an oil pump, or the like. Hand pumps, such as hand pump 964, are commonly used in developing countries to allow people to access water from wells, such as community water wells that supply water to people living in villages or towns without access to running water. Hand pumps can also be used as a back-up water supply for areas with access to running water. Hand pumps can also be used in recreational areas (e.g., camping areas, beaches, sports areas, parts, etc.). Though hand pumps may be available to communities (e.g., villages in developing countries), they may not always be properly functional or maintained. Some solutions have been directed to bringing the responsibility of maintaining the hand pump to residents of the community, however, these solutions may be not always be practical, for example, if the residents do not have adequate knowledge to address an issue with the hand pump. Additionally, water that is pumped by the hand pump for consumption by the residents or livestock of the community may become contaminated (e.g., from the soil or from another source), and the contamination may not be detected by the residents of the village.

The above-mentioned problems may be addressed by installing sensors and wireless modules to monitor the hand pumps for issues or potential issues. For example, if a sensor fails to detect water being dispensed from a hand pump (e.g., despite the handle being raised and lowered), that may indicate that the hand pump is not functioning properly, and that as a result, residents of the community may not be able to access water. The wireless module may notify proper authorities that the hand pump may not be functioning properly. In another example, a sensor may be able to detect a presence of contaminants (such as microbes, bacteria, parasites, heavy metals, pesticides, or the like) in the water being dispensed from the hand pump, and, via the wireless module, notify the proper authorities of the possible contamination of the water. The sensors and the wireless modules require a power source to operate. In certain areas (e.g., developing countries, remote areas), a direct power source (e.g., from a power grid, a replaceable batter, or the like) may not be available and/or may not be reliable. Though there are other sources of power, such as solar, wind, or the like, these sources may not always provide the necessary power when needed. For example, an energy harvester converting solar energy into electrical energy may harvest energy efficiently only during sunny days, and may harvest little to no energy on cloudy days, at night time, or if the solar collector is accidently covered (e.g., by leaves, snow, dust, dirt, objects left behind by people, or the like). In another example, an energy harvester converting wind energy into electrical energy may harvest energy efficiently when the weather is windy. Even if the solar or wind energy harvesters are used to charge a battery or capacitor, during long periods of inefficient energy harvesting, the battery or capacitor may become discharged and no longer able to provide the necessary power for the sensors and wireless modules.

An energy harvesting device (e.g., energy harvesting device 100, 200, 300a, 300b, 400, 900, and/or the like) coupled to a hand pump may provide a reliable source of energy for transmission of sensor data by a wireless module. In some embodiments, the energy harvesting device is constructed using rigid-body mechanisms. In some embodiments, the energy harvesting device is constructed using one or more flexible materials (e.g., compliant materials) which may provide one or more advantages, such as a less parts, less-precise manufacturing of the parts, no lubrication between the parts, etc., which may decrease production cost and increase reliability, making the energy harvesting device suitable for energy harvesting in a developing country or a remote location. Compliant mechanisms may be made of metals, plastics, silicon, rubber, brittle materials, or the like.

The energy harvesting device described in the present disclosure may address the above-mentioned problems and challenges by providing a cost-effective and reliable solution to convert rotational kinetic energy into electrical energy (e.g., without relying on rigid-body mechanisms) and without relying on ambient power sources (e.g., solar, wind, or the like) which may be unpredictable. The hand pump 964 may be a hand pump to pump water and provide water to residents of a community with a need for clean water, according to certain embodiments. The hand pump 964 may include a handle 952. One end of the handle 952 may be coupled to the hand pump 964 via a pivot point 958. The pivot point may be an axis of rotation of the handle 952 (e.g., the oscillation rotational structure). Though some of the following components are not shown in FIG. 9, the shaft 740, the energy generator 742, the battery 744, the circuit 746, the processing device 748, the wireless module 749, and the sensors 750 of FIG. 7 may be coupled to the pump 964, the pump handle 952, and/or the energy harvesting device 900. The energy harvesting device 900 may be coupled (e.g., attached, fixed, mounted) on the handle 952 at a finite distance from the axis of rotation (e.g., the pivot point 958) of the handle 952. The energy harvesting device may be housed in a housing or a casing (e.g., case 854 of FIG. 8).

The pump handle 952 may have a first distal end proximate the pivot point 958 and a second distal end opposite the first distal end. In some embodiments, the energy harvesting device 900 is located proximate the second distal end (e.g., in an end cap of the pump handle 952). In some embodiments, the energy harvesting device 900 is located proximate the first distal end (e.g., within the pump 964). In some embodiments, the energy harvesting device 900 is located part-way between the first distal end and the second distal end. In some embodiments, the handle 952 has an area (e.g., grip area) designated for a user to interface with the handle 952 to oscillate (e.g., perform the up stroke and down stroke of) the handle 952. In some embodiments, the energy harvesting device 900 is located outside of the area designated for a user to interface with the handle 952. In some embodiments, the energy harvesting device 900 is located within the area (e.g., grip) designated for a user to interface with the handle 952.

When the pump 964 is operated (e.g., by a person pumping the hand pump) the handle 952 is pumped up and down causing the energy harvesting device to be moved on an arc of a circle centered on the axis of rotation of the handle 952. The energy harvesting device is coupled to a shaft 740, as described with respect to FIG. 7. A first distal end of the shaft 740 running parallel to the axis of rotation of the handle 952 is coupled to the energy harvesting device 900, such as at the center of a hub (such as hub 102 of FIG. 1) of the energy harvesting device 900. An axis of rotation of the energy harvesting device 900 may be defined by the shaft 740. The rotational oscillation of the handle 952 causes the energy harvesting device 900 to rotate about the axis of rotation of the energy harvesting device 900. The rotation of the energy harvesting device 900 may cause the shaft 740 to rotate about the axis of rotation of the energy harvesting device 900. A second distal end of the shaft 740 is coupled to the energy generator 742. The shaft 740 drives the energy generator 742 in response to the rotation of the energy harvesting device 900. The energy generator 742 may generate energy (e.g., electrical energy) in response to being driven by the shaft. The energy that is generated by the energy generator 742 may be stored in the battery 744 which may be coupled to the processing device 748. The processing device 748 may be configured to receive the energy generated by the rotation of the energy harvesting device 900. Sensor 750 may be configured to perform a sense measurement and obtain sensor data. The processing device 748 may be configured to receive the sensor data from the sensor and transmit the sensor data via a wireless module 749.

The energy harvesting device 900 may be able to provide energy to charge the battery 744 and/or power the sensors 750, wireless module 749, and/or processing device 748 (e.g., microcontroller) when power is needed. In one embodiment, energy is generated by the energy harvesting device 900 when the hand pump is being operated. In other embodiments, the energy harvesting device may continue to rotate for a short amount of time after the pump is no longer being operated (e.g., when the handle of the pump is no longer being pumped) and may continue to provide electrical energy for the short amount of time. In some embodiments, the energy harvesting device provides enough energy to charge the battery to store power to power the sensors, wireless module, and processing device even when the pump is not being operated.

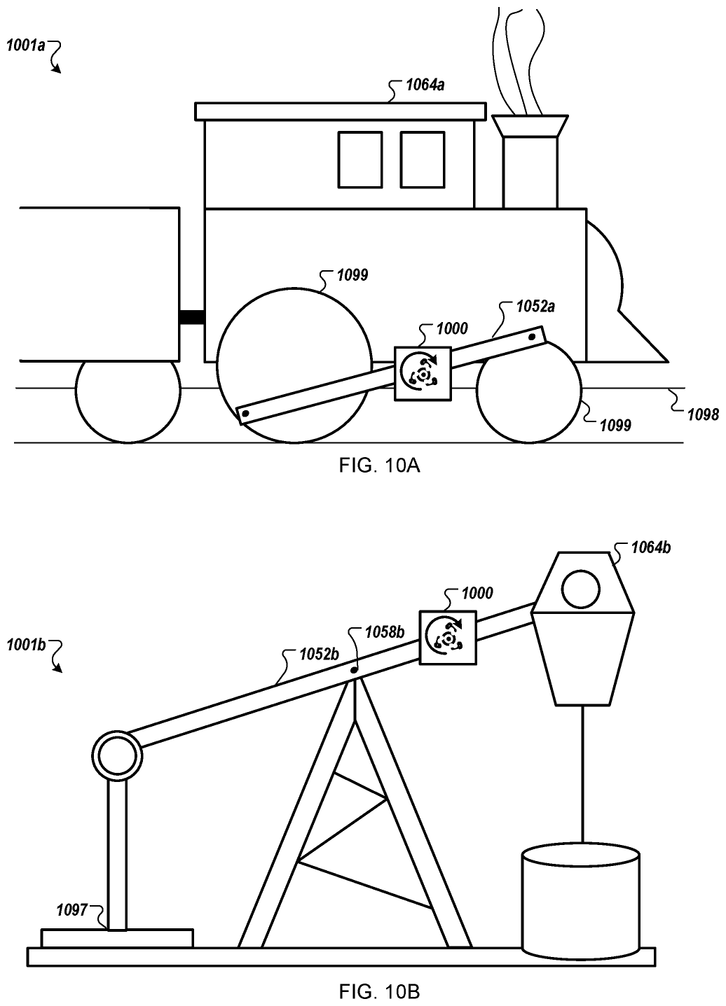

FIG. 10A is an energy harvesting system 1001a including a train 1064a with an energy harvesting device 1000 coupled to a strut 1052a of the train, according to certain embodiments. Though not all of the details and components of the energy harvesting device 1000 are shown, it should be understood that the energy harvesting device 1000 may include all components and features of the energy harvesting device described in the present disclosure. A train may include wheels 1099 (e.g., driving wheels) that are coupled together via rods (e.g., side rods, coupling rods, train strut 1052a, or the like) that may act as an oscillation rotation structure that the energy harvesting device 1000 may be coupled to. The energy harvesting device may rotate in a first direction about a first axis of rotation located at the center of the energy harvesting device, responsive to the rotational oscillation motion of the train strut as the train is driven along a track 1098. The rotation of the energy harvesting device may be used to drive an energy generator (such as generator 742 of FIG. 7) in order to generate electrical energy, either to directly power a low-power consumption device or charge a battery. The low-power consumption device may be a sensor, a microcontroller, a wireless module, a processing device or the like. The sensor may be an accelerometer, a strain gauge, a water or humidity sensor, a proximity sensor, a battery level sensor, or the like, such as those described at least in reference to FIG. 7. Sensor data may allow for remote monitoring of various aspects and/or parameters of the train (e.g., strain, oscillations of the strut, oscillation speed, temperature, wind speed, etc.). In some embodiments, a company operating a train may have interest in monitoring when the train is in motion and when the train is stopped, and may install an accelerometer on the train. In other embodiments, a temperature sensor may be installed in the engine of the train to allow the driver of the train to monitor the temperature of the engine. Various aspects and/or parameters of the train may be sensed by sensors, and wirelessly transmitted to a remote location, and may provide information on whether the train or parts of the train may require maintenance, repair, replacement, or the like.

FIG. 10B is an energy harvesting system 1001b including an oil rig 1064b with an energy harvesting device 1000 coupled to an arm 1052b of the oil rig, according to certain embodiments. Though not all of the details and components of the energy harvesting device 1000 are shown, it should be understood that the energy harvesting device 1000 may include all components and features of the energy harvesting device described in the present disclosure. An oil rig may include a drill 1097 that is operated and made to move in an oscillating (e.g., up and down) pattern by an arm 1052b that acts as an oscillation rotation structure to which the energy harvesting device 1000 may be coupled. The energy harvesting device may rotate in a first direction about a first axis of rotation located at the center of the energy harvesting device, responsive to the rotational oscillation motion of the arm 1052b. The arm 1052b may rotate about a second axis of rotation located at pivot point 1058b. The rotation of the energy harvesting device may be used to drive an energy generator (such as generator 742 of FIG. 7) in order to generate electrical energy, either to directly power a low-power consumption device or charge a battery. The low-power consumption device may be a sensor, a microcontroller, a wireless module, a processing device or the like. The sensor may be an accelerometer, a strain gauge, a water or humidity sensor, a proximity sensor, a battery level sensor, or the like, such as those described at least in reference to FIG. 7. Sensor data may allow for remote monitoring of various aspects and/or parameters of the oil rig. In some embodiments, a company operating an oil rig may have interest in monitoring the quantity of oil being pumped, and may install an accelerometer or other sensor on the arm of the oil rig in order to count the number of oscillations (e.g., pumps). In other embodiments, a sensor may be installed to monitor for the quality of oil being pumped by the oil rig. Various aspects and/or parameters of the oil may be sensed by sensors, and wirelessly transmitted to a remote location, and may provide information on the quality of the oil being pumped by the oil rig, or whether the oil rig or parts of the oil may require maintenance, repair, replacement, or the like.

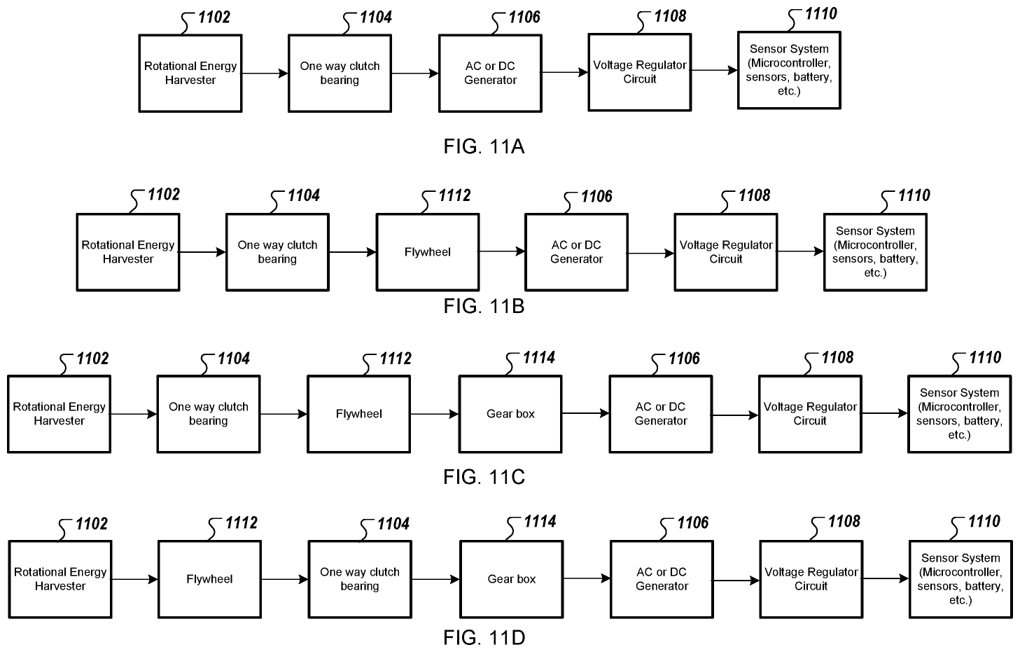

FIGS. 11A-11D are block diagrams illustrating various energy harvesting systems, according to embodiments of the present disclosure. In FIG. 11A, an energy harvesting device 1102 (also referred to as a rotational energy harvesting device and rotational energy harvester herein) may be coupled to a one-way clutch bearing 1104 (such as a sprag clutch, a one-way freewheel clutch, or the like). The one-way clutch bearing 1104 may allow for rotational motion in only one direction (e.g., rotation in a first may be permitted, but rotation in a second direction opposite from the first direction may not be permitted). The one-way clutch bearing 1104 may be coupled to a generator 1106 (such as an AC generator or a DC generator). The generator 1106 may be coupled to voltage regulator circuit 1108. Voltage regulator circuit 1108 may be coupled to a sensor system 1110. The sensor system 1110 may include a microcontroller (such as the microcontrollers described in reference to FIGS. 7 and 10), a battery (such as battery 744 of FIG. 7), and various sensors (such as an accelerometer, a strain gauge, a water or humidity sensor, a proximity sensor, a battery level sensor, or the like). The sensor system 1110 may further include low-power consumption devices such as wireless transmitters and/or receivers.

The energy harvesting system of FIG. 11B may be similar to the energy harvesting system of FIG. 11A. FIG. 11B may also have a flywheel 1112 coupled between the one-way clutch bearing 1104 and the generator 1106. The flywheel 1112 may be a single mass flywheel, dual mass flywheel, or the like and may be designed to store rotational kinetic energy.

The energy harvesting system of FIG. 11C may be similar to the energy harvesting system of FIG. 11B. FIG. 11C may have a gearbox 1114 coupled between the flywheel 1112 and the generator 1106. The gearbox 1114 may be a helical gearbox, a worm reduction gearbox, a planetary gearbox, or the like to increase or decrease torque.

FIG. 11D may be similar to the energy harvesting system of FIG. 11C. In some embodiments, in FIG. 11D, the flywheel 1112 is coupled to the rotational energy harvesting device 1102, the one-way clutch bearing 1104 is coupled to the flywheel, and the gearbox 1114 is coupled to the one-way clutch bearing 1104.

In each of the energy harvesting systems of FIGS. 11A-11D, the rotational energy harvesting device 1102, the one-way clutch bearing 1104, and the generator 1106 may be used. Each of the energy harvest systems of FIGS. 11A-D may include the voltage regular circuit. The flywheel 1112 and the gearbox 1114 may be included and the order in which they are coupled between the rotational energy harvesting device 1102 and the gearbox 1114 may be varied depending on a configuration and behavior of the system (e.g., hand pump, train strut, oil rig, etc.) from which the energy is being harvested. The sensor system 1110 is powered by the energy harvesting system, although the energy harvesting system may include further components to receive the energy. It should be noted that FIGS. 11A-11D are shown to illustrate examples of an energy harvesting system, though other energy harvesting systems may be provided by adding, removing, or rearranging the components.

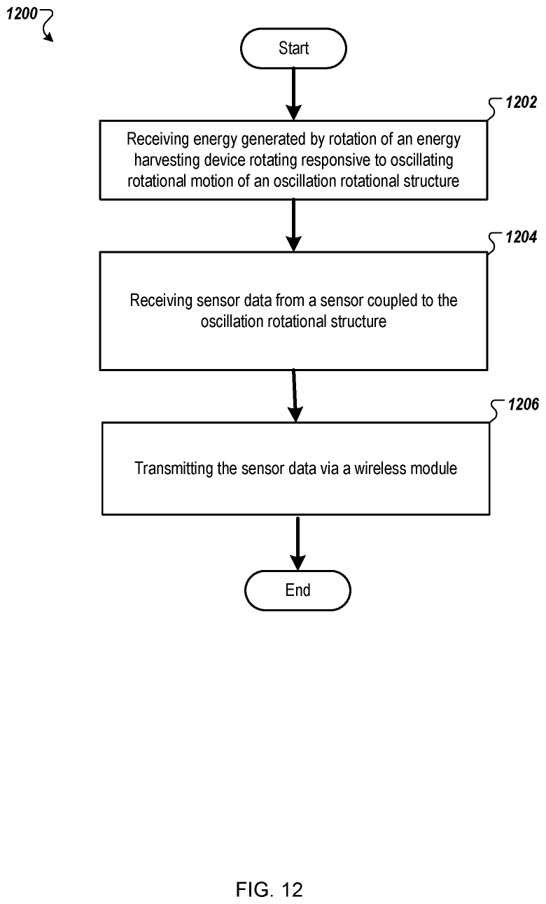

FIG. 12 is a flow diagram of a method 1200 associated with an energy harvesting device, according to certain embodiments. The method 1200 may be performed by a processing device that includes hardware (e.g., circuitry, dedicated logic, programmable logic, microcode, etc.), software, firmware, or a combination thereof. In one embodiment, a processing device coupled to an energy harvesting device performs the method 1200. In another embodiment, the energy harvesting system of FIG. 7 performs the method 1200. In another embodiment, the hand pump of FIG. 9 performs the method 1200. In another embodiment, the energy harvesting system of FIG. 10 performs the method 1200. In other embodiments, one or more energy harvesting systems of FIGS. 11A-11D perform the method 1200.

Referring to FIG. 12, at block 1202, the processing device receives energy generated by rotation of an energy harvesting device responsive to oscillating rotational motion of an oscillation rotational structure (e.g., handle of a hand pump). In some embodiments, the energy harvesting device of block 1202 may be one or more of the energy harvesting device 100 of FIG. 1, the energy harvesting device 200 of FIG. 2, the energy harvesting device 300a of FIG. 3A, the energy harvesting device 300b of FIG. 3B, one or more of the energy harvesting devices of FIGS. 4A-4C, the energy harvesting device 500 of FIG. 5, the energy harvesting device of FIG. 6, the energy harvesting device 700 of FIG. 7, the energy harvesting device 800 of FIG. 8, the energy harvesting device 900 of FIG. 9, the energy harvesting device 1000 of FIG. 10, one or more of the energy harvesting devices 1102 of FIG. 11A-11D. In some embodiments, the energy harvesting device of block 1202 includes elastic material (e.g., compliant material). The energy harvesting device may be caused to rotate in a first direction about a first axis of rotational along a shaft responsive the oscillating rotational motion of the oscillation rotational structure. The rotation of the energy harvesting device in the first direction may cause the shaft to rotate about the first axis of rotation and drive a generator coupled to the shaft. The generator generates electrical energy responsive to being driven by the shaft. In some embodiments, the electrical energy generated by the generator is transmitted to the processing device. In some embodiments, the electrical energy generated by the generator is stored in a battery and the processing device receives the electrical energy from the battery.

At block 1204, the processing device receives sensor data from a sensor coupled to the oscillation rotational structure. The sensor coupled to the oscillation rotational structure may collect sensor data such as an acceleration, strain, humidity, proximity, battery level, or the like depending on the type of sensor.

At block 1206, responsive to receiving the sensor data from the sensor, the processing device may cause the sensor data to be transmitted via a wireless module. In some embodiments, one or more of the processing device, the sensor, and/or the wireless module may be powered directly by the energy harvesting device. In some embodiments, the energy harvesting device may charge a battery, and the battery may be used to power one or more of the processing device, the sensor, and/or the wireless module.

To generate energy, the energy harvesting device rotates about an axis (e.g., the first axis of rotation) of a hub structure of the energy harvesting device responsive to oscillating rotational motion of the oscillation rotational structure. The shaft includes a first distal end coupled to the hub structure at the axis of the hub structure. The shaft further includes a second distal end coupled to the generator. The shaft drives the generator responsive to the rotation of the energy harvesting device. Responsive to being driven by the shaft, the generator generates the energy which may be used to directly provide power to the processing device, the sensor, and the wireless module, or which may be stored in a battery coupled to the processing device.

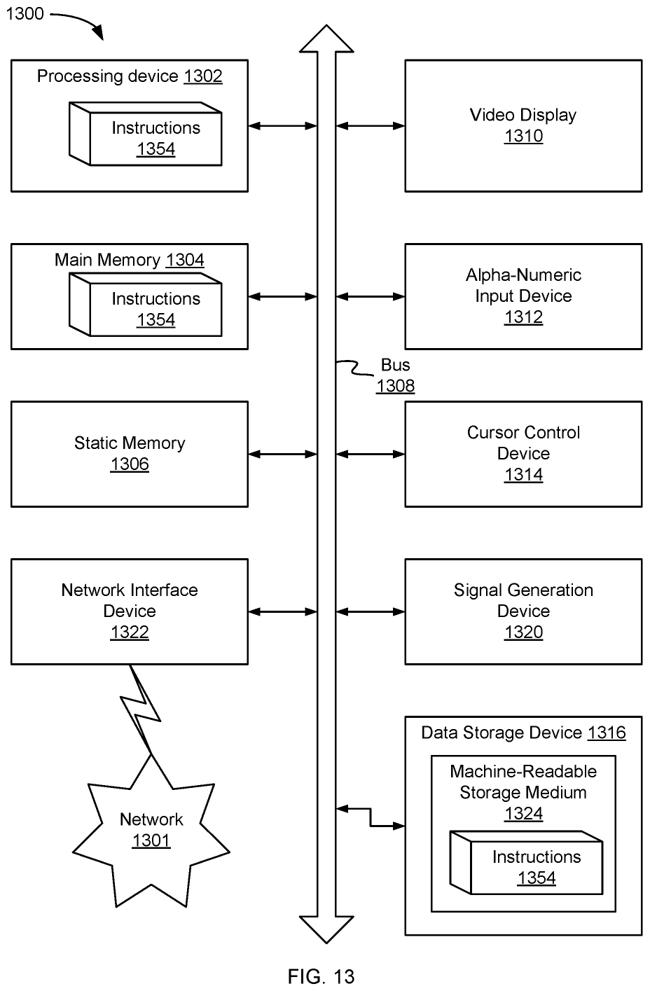

FIG. 13 illustrates a component diagram 1300 of a computer system which may implement one or more methods of generating electrical power or computing values for generating electrical power described herein. A set of instructions for causing the computer system 1300 to perform any one or more of the methods discussed herein may be executed by the computer system 1300. In some embodiments, the computer system 1300 may implement the functions of one or more of the energy harvesting system 901 of FIG. 9, energy harvesting system 1001a of FIG. 10A, and/or 1001b of FIG. 10B.

In one embodiment, the computer system 1300 may be connected to other computer systems by a network 1301 provided by a Local Area Network (LAN), an intranet, an extranet, the Internet or any combination thereof. The computer system may operate in the capacity of a server or a client machine in a client-server network environment or as a peer machine in a peer-to-peer (or distributed) network environment. The computer system may be a personal computer (PC), a tablet PC, a set-top box (STB), a Personal Digital Assistant (PDA), a cellular telephone, a web appliance, a server, a network router, switch, bridge or any machine capable of executing a set of instructions (sequential or otherwise) that specify actions to be taken by that machine. Further, while a single machine is illustrated, the term “computer system” shall also be taken to include any collection of machines (e.g., computers) that individually or jointly execute a set (or multiple sets) of instructions to perform any one or more of the methodologies discussed herein.

In one embodiment, the computer system 1300 includes a processing device 1302 (e.g., microcontroller), a main memory 1304 (e.g., read-only memory (ROM), flash memory, dynamic random access memory (DRAM) such as synchronous DRAM (SDRAM), etc.), a static memory 1306 (e.g., flash memory, static random access memory (SRAM), etc.) and a data storage device 1316, which communicate with each other via a bus 1308.

In one embodiment, the processing device 1302 represents one or more general-purpose processors such as a microprocessor, central processing unit or the like. Processing device may include any combination of one or more integrated circuits and/or packages that may, in turn, include one or more processors (e.g., one or more processor cores). Therefore, the term processing device encompasses a single core CPU, a multi-core CPU and a massively multi-core system that includes many interconnected integrated circuits, each of which may include multiple processor cores. The processing device 1302 may therefore include multiple processors. The processing device 1302 may include a complex instruction set computing (CISC) microprocessor, reduced instruction set computing (RISC) microprocessor, very long instruction word (VLIW) microprocessor, processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor or the like.

The processing device 1302 may be the processing device of one or more of the energy harvesting system 901 of FIG. 9, energy harvesting system 1001a of FIG. 10A, and/or 1001b of FIG. 10B. The processing device 1302 may perform the method of claim 12. The processing device 1302 may include one or more interfaces to connect to one or more of wireless modules 749, batteries 744, generators 742, processing devices 748 (e.g., microcontrollers), sensors 750, charging circuitry 746 of FIG. 7, and the like.

In one embodiment, the computer system 1300 may further include one or more network interface devices 1322. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse) and a signal generation device 1320 (e.g., a speaker).

In one embodiment, the data storage device 1318 may include a computer-readable storage medium 1324 on which is stored one or more sets of instructions 1354 embodying any one or more of the methods or functions described herein. The instructions 1354 may also reside, completely or at least partially, within the main memory 1304 and/or within the processing device 1302 during execution thereof by the computer system 1300; the main memory 1304 and the processing device 1302 also constituting machine-readable storage media. The computer-readable storage medium 1324 may be a non-transitory computer-readable storage medium.

While the computer-readable storage medium 1324 is shown as a single medium, the term “computer-readable storage medium” should be taken to include a single medium or multiple media (e.g., a centralized or distributed database and associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methods described herein. Examples of computer-readable storage media include, but not limited to, solid-state memories, optical media and magnetic media. The preceding description sets forth numerous specific details such as examples of specific system, components, devices and so forth in order to provide a good understanding of several embodiments of the present disclosure. It will be apparent to one skilled in the art, however, that at least some embodiment of the present disclosure may be practiced without these specific details. In other instances, well-known components or methods are not described in detail to avoid unnecessarily obscuring the present disclosure. Thus, the specific details set forth are merely exemplary. Particular implementations may vary from these exemplary details and still be contemplated to be within the scope of the present disclosure.

Reference throughout this specification to “some embodiments,” “one embodiment,” or “an embodiment” means that a particular feature, structure, or characteristic described in connection with the embodiment is included in at least one embodiment. Thus, the appearance of the phrase “in some embodiments,” “in one embodiment,” or “in an embodiment” in various places throughout this specification are not necessarily all referring to the same embodiment. Furthermore, a person having ordinary skill in the art will recognize that the elements, components, and devices found in an embodiment of the system may be combined with any element, component, or device of another embodiment and that the use of any specified element, component, or device is not isolated to the exemplary embodiment within where it is described. In addition, the term “or” is intended to mean an inclusive “or” rather than an exclusive “or.” When the term “about”, “approximately”, or “substantially” is used herein, this is intended to mean the nominal value or characteristic presented is precise within ±10%.

The terms “over,” “above” “under,” “between,” and “on” as used herein refer to a relative position of one material layer or component with respect to other layers or components. For example, one element, component, or device disposed above, over, or under another element, component, or device may be directly in contact with the other element, component, or device or may have one or more intervening elements, components, or devices. Moreover, one element, component, or device disposed between two elements, components, or devices may be directly in contact with the two elements, components, or devices or may have one or more intervening elements, components, or devices. Similarly, unless explicitly stated otherwise, one feature disposed between two features may be in direct contact with the adjacent features or may have one or more intervening features.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “causing,” “providing,” “maintaining,” “generating,” “rotating,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present invention as described herein. It should also be noted that the terms “when” or the phrase “in response to,” as used herein, should be understood to indicate that there may be intervening time, intervening events, or both before the identified operation is performed.

It is understood that the above description is intended to be illustrative, and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. An energy harvesting device comprising:
a hub structure configured to rotate about an axis;
a first arm comprising:
a first hinge connecting a first proximal end of the first arm to the hub structure;
a first weight coupled to a first distal end of the first arm; and
a second arm comprising:
a second hinge connecting a second proximal end of the second arm to the hub structure; and
a second weight coupled to a second distal end of the second arm.

2. The energy harvesting device of claim 1, wherein the first hinge comprises an elastic material to store energy to produce a motion by catapulting in a forward direction at a threshold point.

3. The energy harvesting device of claim 2, wherein the first hinge comprises protrusions to prevent deflections of the first hinge in one or more directions.

4. The energy harvesting device of claim 1, wherein the first hinge comprises a pin to rotationally couple the first arm to the hub structure.

5. The energy harvesting device of claim 1 further comprising a ratcheting device coupled to a central portion of the hub structure to allow the hub structure to rotate in a first direction and to prevent the hub structure from rotating in a second direction opposite the first direction.

6. The energy harvesting device of claim 1, wherein the hub structure, the first arm, and the second arm are integral to each other.

7. The energy harvesting device of claim 1, wherein the first arm comprises a backstop proximate to the first hinge to contact the hub structure.

8. The energy harvesting device of claim 1 comprising a plurality of arms, wherein the plurality of arms comprises the first arm and the second arm, and wherein each arm of the plurality of arms is equally spaced around the hub structure.

9. The energy harvesting device of claim 1, wherein the hub structure forms a recess to receive at least a portion of the first arm.

10. The energy harvesting device of claim 1, wherein the energy harvesting device is to rotate to power:
a sensor for one or more of a hand pump, an oil rig, or a train strut; and
a wireless module.

11. A system comprising:
an energy harvesting device comprising:
a hub structure comprising a central portion configured to rotationally couple to an oscillation rotational structure along a first axis of rotation, wherein the oscillation rotational structure to perform oscillating rotational motion;
a first arm comprising:
a first hinge connecting a first proximal end of the first arm to the hub structure;
a first weight coupled to a first distal end of the first arm; and
a second arm comprising:
a second hinge connecting a second proximal end of the second arm to the hub structure; and
a second weight coupled to a second distal end of the second arm.

12. The system of claim 11 further comprising:
an energy generator coupled to the energy harvesting device; and
a battery coupled to the energy generator, wherein the battery is to be charged by the energy generator responsive to rotation of the energy harvesting device.

13. The system of claim 12 further comprising:
a sensor to provide sensor data;
a wireless module to be powered by the battery; and
a processing device to receive the sensor data and to transmit the sensor data via the wireless module.

14. The system of claim 13, wherein one or more of:
the sensor is an accelerometer;
the sensor data comprises oscillation rotational measurements;
the sensor is a strain gauge; or
the sensor data is to be used to perform structural health monitoring.

15. The system of claim 11, wherein the energy harvesting device is to rotate around the first axis of rotation, wherein the oscillation rotational structure is to perform the oscillating rotational motion relative to a second axis of rotation that is parallel to the first axis of rotation.

16. The system of claim 11, wherein the first arm and the second arm are coupled to an outside perimeter of the hub structure, and wherein the first hinge and the second hinge are to prevent the first arm and the second arm from deflecting from being normal to the first axis of rotation.

17. The system of claim 11, wherein the oscillation rotational structure is one or more of a:
a handle of a hand pump;
an arm of an oil rig; or
a train strut.

18. A method comprising:
receiving, by a processing device, energy generated by a rotation of an energy harvesting device rotating responsive to an oscillating rotational motion of an oscillation rotational structure;
receiving, by the processing device, sensor data from a sensor coupled to the oscillation rotational structure; and
causing, by the processing device, the sensor data to be transmitted via a wireless module.

19. The method of claim 18, wherein:
the energy harvesting device rotates about an axis of a hub structure of the energy harvesting device responsive to the oscillating rotational motion of the oscillation rotational structure;
a shaft comprises a first distal end coupled to the hub structure at the axis of the hub structure and a second distal end coupled to an energy generator; and
the shaft drives the energy generator responsive to the rotation of the energy harvesting device.

20. The method of claim 19, wherein:
responsive to the shaft driving the energy generator, the energy generator generates the energy; and the energy is stored in a battery coupled to the processing device.
